(19) United States
(12) Patent Application Publication
(10) Pub. No.: US 2021/0191491 A1
(43) Pub. Date: Jun. 24, 2021

(54) AWAKENING ELECTRONIC DEVICES IN SELECTED MODES OF OPERATION

(71) Applicant: HEWLETT-PACKARD DEVELOPMENT COMPANY, L.P.

(72) Inventors: Thai THONG, Houston, TX (US); Rahul V. LAKDAWALA, Houston, TX (US); Syed S. AZAM, Houston, TX (US)

(73) Assignee: HEWLETT-PACKARD DEVELOPMENT COMPANY, L.P., Houston, TX (US)

(21) Appl. No.: 16/078,384

(22) PCT Filed: Oct. 24, 2016
(86) PCT No.: PCT/US2016/058505

§ 371 Date: Aug. 21, 2018

(51) Int. Cl. G06F 1/3206

(52) U.S. Cl. CPC G06F 1/3206; G06F 1/1616

(57) ABSTRACT

In some examples, an electronic device is to receive a wake event, and in response to the wake event, awaken the electronic device from a sleep state to a higher power state in a selected mode of operation of the electronic device that depends on outputs from sensors of the electronic device, the selected mode of operation selected from among a plurality of different modes of operation that use multiple displays of the electronic device.

### BACKGROUND

Electronic devices can include various electronic components, including processors, memory devices, input/output (I/O) devices, and so forth. An electronic device can be transitioned between a lower power state and a higher power state. In the lower power state, various electronic components in an electronic device can be powered off, to conserve power. In the higher power state, electronic components of the electronic device can be powered on to allow normal operation of the electronic device.

### BRIEF DESCRIPTION OF THE DRAWINGS

Some implementations of the present disclosure are described with respect to the following figures.

FIG. 1A is a schematic perspective view of an electronic device according to some examples.

FIG. 1B is a block diagram of an electronic device that is able to awaken to a selected mode of operation according to some examples.

FIGS. 2A-2C illustrate various different modes of operation of an electronic device according to some examples.

FIG. 3 is a block diagram of an electronic device according to further examples.

FIG. 4 is a flow diagram of a process to awaken an electronic device according to some examples.

FIG. 5 is a block diagram of a storage medium storing machine-readable instructions according to some examples.

### DETAILED DESCRIPTION

In the present disclosure, the article “a,” “an”, or “the” can be used to refer to a singular element, or alternatively to multiple elements unless the context clearly indicates otherwise. Also, the term “includes,” “including,” “comprises,” “comprising,” “have,” or “having” is open ended and specifies the presence of the stated element(s), but does not preclude the presence or addition of other elements.

Examples of electronic devices include desktop computers, notebook computers, tablet computers, and so forth. Some electronic devices can be used in different modes, such as a clamshell mode (where an electronic device operates as a notebook computer) or a tablet mode (where an electronic device operates as a tablet computer). In the clamshell mode, a display unit of an electronic device is pivoted to an angle with respect to a base unit of the electronic device. The display unit includes a display device to display images to the user. The base unit can include a user input device, such as a physical keyboard, a physical touchpad, or a physical pointer device, to allow a user to make inputs to the electronic device. In the tablet mode, the display unit and the base unit of the electronic device are folded together such that the rear surfaces of the display unit and the display unit touch each other, and the display device of the display unit faces outwardly towards a user. The display device is a touch-sensitive display device that allows the user to make inputs using the touch-sensitive display device in the tablet mode, instead of using a user input device on the base unit of the electronic device. It is noted that in some cases, in the clamshell mode, a user can also make inputs using the touch-sensitive display device of the electronic device, in addition to using the user input device on the base unit.

Although some electronic devices can be used in multiple modes, they still do not offer flexibility in the number of modes in which the electronic device can be used, particularly in the context of awakening the electronic device from a lower power state to a higher power state. A lower power state of an electronic device refers to a state of the electronic device that consumes less power than a higher power state of the electronic device. For example, in the lower power state, an electronic component, or multiple electronic components, of the electronic device can be powered off. In the higher power state, an electronic component of the electronic device that was powered off in the lower power state is powered on in the higher power state, to allow for the electronic device to operate in a target manner. In the ensuing discussion, a lower power state is referred to as a sleep state, while the higher power state is referred to as an operational state.

In accordance with some implementations of the present disclosure, an electronic device can be provided with multiple displays to allow for an increased number of modes of operation of the electronic device. For example, in addition to the clamshell mode and the tablet mode, the electronic device can further be set for operation in a further mode (with some examples discussed further below). With electronic devices that can be operated in a greater number of modes of operation, some example mechanisms to awaken the electronic devices from a sleep state may not be adequate to cause the electronic devices to awaken to an operational state in the appropriate mode of operation. For example, activating a power button, opening a display unit of an electronic device, or receiving a packet over a network can trigger an interrupt to awaken the electronic device from the sleep state to the operational state. However, in some example electronic devices, mechanisms are not provided to allow the electronic devices to awaken into an appropriate mode of operation depending on a context of the electronic devices, such as its orientation, a rotational angle of a display unit relative to a base unit of the electronic device, and/or other factors.

In accordance with some implementations of the present disclosure, during the process of awakening an electronic device from a sleep state to an operational state (a transition between a lower power state and a higher power state), events corresponding to various sensors of the electronic device can be used to set the electronic device in a selected mode of operation, where the selected mode of operation is selected from multiple different modes of operation, depending on the context of the electronic device as determined from outputs of the sensors. The different modes of operation can correspond to different power levels. As a result, setting the electronic device to an appropriate mode of operation based on its context can enhance power savings. Also, the different modes of operation use multiple displays of the electronic device in different ways.

For example, in a first mode of operation, a first display can present a user interface device (such as a keyboard), while a second display can present an application image (an image generated by an application executed in the electronic device). Note that the user interface device (such as the keyboard) is a virtual user interface device displayed by the first display. In a second mode of operation, corresponding program images can be displayed by the multiple displays, where a “program image” can refer to an image (e.g., a graphical user interface screen, a picture, a video, text, etc.) generated by an application, an operating system, a firmware program, or any other machine-readable instructions. In yet a further mode of operation, one of the displays can be deactivated. There can be further modes of operation that use the multiple displays of the electronic device in different ways.

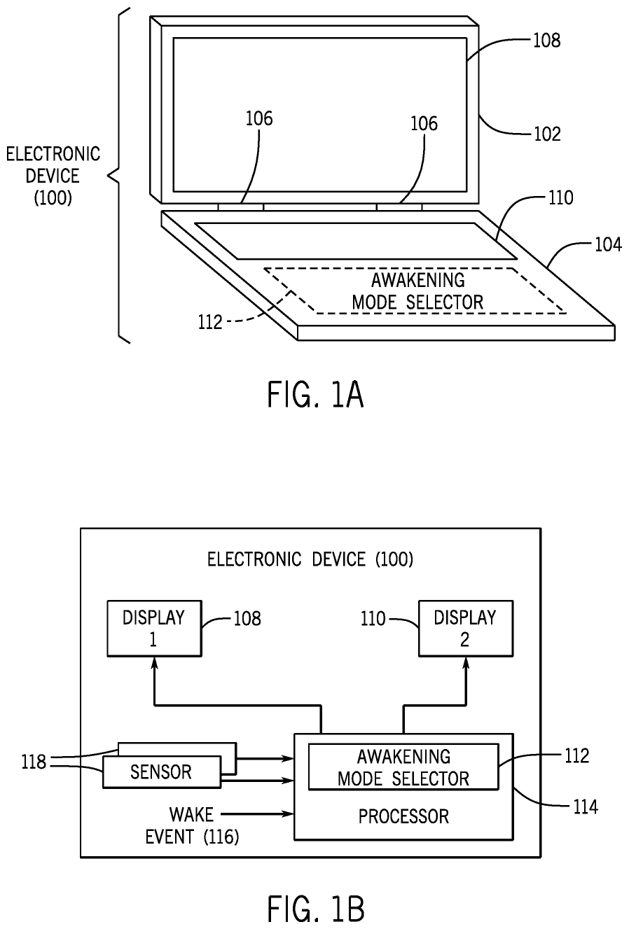

FIGS. 1A and 1B show an electronic device 100 that has a display unit 102 and a base unit 104, where the display unit 102 is pivotally attached to the base unit 104 by a hinge 106, or by multiple hinges 106. The display unit 102 includes a first display 108, and the base unit 104 includes a second display 110. In further examples, more than two displays can be included in the electronic device 100.

The displays 108 and 110 can display different information depending upon the mode of operation of the electronic device 100. In the clamshell mode of operation depicted in FIG. 1A, where the display unit 102 is angled with respect to the base unit 104 such that the user can see both the displays 108 and 110 of the electronic device 100, the display 108 of the display unit 102 can be used to display information, such as program images or other information. The display 110 of the base unit 104 can be used to display a virtual user input device, such as a keyboard or other type of input device, including control elements that can be touched or selected by a user.

In a different clamshell orientation of the electronic device 100, the display 110 of the base unit 104 can be used to display information, such as program images or other information, while the display 108 of the display unit 102 can be used to display a virtual user input device.

The electronic device 100 includes an awakening mode selector 112 according to some implementations that can be used to awaken the electronic device 100 from a sleep state to an operational state in a selected mode of operation that is selected from multiple different modes of operation that use the multiple displays 108 and 110, where a first mode of operation uses the multiple displays in a way that is different from a second mode of operation.

As further shown in FIG. 1B, the electronic device 100 includes a processor 114 that includes the awakening mode selector 112. The processor can include any or some combination of the following: a microprocessor, a core of a multi-core microprocessor, a microcontroller, a programmable gate array, a programmable integrated circuit device, or any other hardware processing circuit. In other examples, the processor 114 can include a combination of a hardware processing circuit and machine-readable instructions executable on the hardware processing circuit. The awakening mode selector 112 includes a portion of the hardware processing circuit of the processor 114, or alternatively, the awakening mode selector includes machine-readable instructions executable on the processor 114.

The processor 114 can receive a wake event 116, which can be an event that is responsive to an interrupt that is to trigger the electronic device 100 to awaken from a sleep state to an operational state. For example, an interrupt may be generated in response to a user pressing a power button, opening the display unit 102 from a closed position to an open position, or touching another user input device, such as a button, a keyboard, a mouse, a touchpad, and so forth. In further examples, the wake event 116 may be responsive to an interrupt generated in response to a packet received over a network by the electronic device 100. In other examples, the wake event 116 may be responsive to an interrupt from a sensor, such as any of sensors 118 in the electronic device 100.

Generally, the wake event 116 can be responsive to detecting an interrupt produced responsive to an output of a sensor, an actuation of a user input device, or a network connection.

Various different sensors 118 can be included in the electronic device 100. A hinge position sensor can sense an angular position of a hinge 106 due to rotation of the display unit 102 with respect to the base unit 104, such that the sensor 118 can cause an interrupt to be generated in response to movement of the display unit 102 relative to the base unit 104. In further examples, the hinge position sensor can cause different interrupts to be generated for different rotational angles of the hinge. For example, a first interrupt can be triggered by the hinge position sensor in response to a first rotational angle of the hinge (e.g., the first rotational angle corresponds to the clamshell mode of operation). A second interrupt can be trigged by the hinge position sensor in response to a second rotational angle of the hinge (e.g., a 360° rotational angle corresponding to the tablet mode of operation). In further examples, additional interrupt(s) can be triggered in response to other rotational angles of the hinge.

Another sensor 118 can be a motion sensor, such as an accelerometer, to detect motion. Yet a further sensor can include a gyroscope to detect an orientation of the electronic device 100. Another sensor 118 can include a light sensor to detect an amount of light around the electronic device 100. A further sensor 118 can be a proximity sensor to detect proximity of a user to the electronic device 100. In some examples, the proximity sensor can be a light sensor that measures reflected light to detect distance of a display to an object, such as a person.

As a further example, a sensor 118 can include a camera to perform eye tracking of a user, to determine a focus of the user. Depending on the focus of the user, selected portions of either or both of the displays 108 and 110 can be turned off in a respective mode of operation.

Each of the sensors 118 can trigger generation of an interrupt in response to detecting events that satisfy respective criteria (e.g., the motion detects motion of greater than a specified threshold, the light sensor detects light less than a specified threshold or greater than a specified threshold, the proximity sensor detects a user close to the electronic device 100, etc.).

Although FIG. 1A shows the electronic device 100 in the clamshell mode of operation, it is noted that the electronic device 100 can be used in other modes of operation. The hinges 106 allow the display unit 102 to be rotated by about 360° with respect to the base unit 104 to provide the tablet mode of operation. When the display unit 102 is rotated by about 360° with respect to the base unit 104, the rear surfaces of the display unit 102 and the base unit 104 can touch each other, and one of the displays 108 and 110 can face outwardly and towards the user. The other of the displays 108 and 110 lays on a surface, such as a desktop or a user's lap. In the tablet mode of operation, the electronic device 100 can be used as a tablet computer, where the display device 108 or 110 can be a touch-sensitive display device for displaying information as well as to accept user touch inputs.

Another mode of operation is a flat mode of operation, where the display unit 102 is rotated by about 180° with respect to the base unit 104, and the electronic device 100 is laid flat on a planar surface, such as the a desktop. In the flat mode of operation, both the displays 108 and 110 can be used to display information, and both the displays 108 and 110 can accept touch inputs. For example, in the flat mode of operation, the display 108 can display a first program image, and the display 110 can display a second program image different from the first program image.

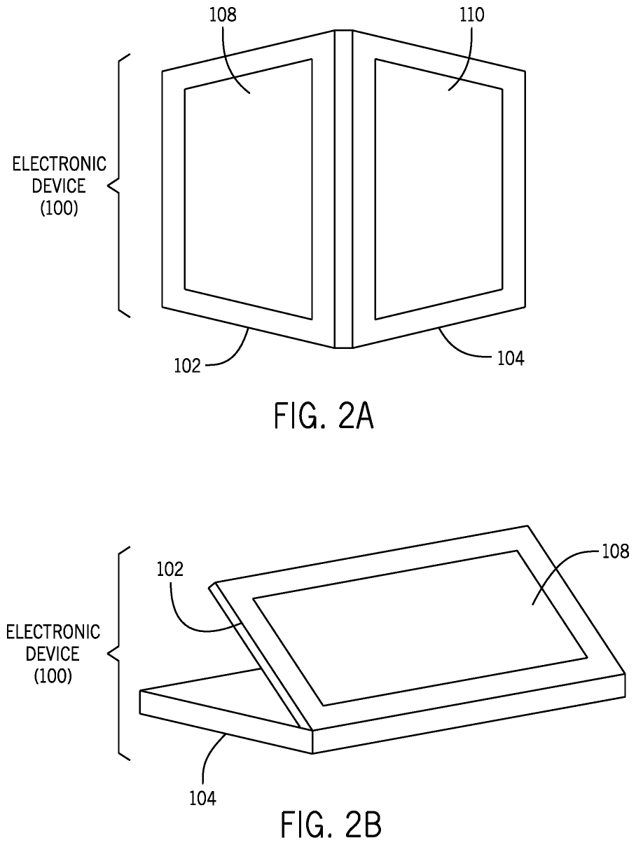

As shown in FIG. 2A, another mode of operation is a tent mode of operation, where the display unit 102 is pivoted to be angled with respect to the base unit 104, and the electronic device is placed generally in a portrait orientation. In the tent mode of operation shown in FIG. 2A, a first display 108 can be facing a first user, while the second display 110 can be facing a second user. In this mode of operation, the displays 108 and 110 can display identical information, such that both users are seeing the same information (e.g., same program image0, or alternatively, the display 108 can present display information tailored to the first user, and the display 110 can display information tailored to the second user.

In some examples, in the tent mode of operation, proximity sensors of the electronic device 100 can detect if users are in the proximity of the respective displays 108 and 110. If the proximity sensors 108 and 110 detect proximity of the users to the displays 108 and 110, then the electronic device 100 can activate both the displays 108. However, if the proximity sensors detect that no user is in the proximity of one of the displays 108 and 110, then the electronic device 100 can deactivate that display.

FIG. 2B shows a stand mode of operation, where the display unit 102 has been rotated by greater than 270° with respect to the base unit 104, such that the display 108 of the display unit 102 is at an angle and faces toward the user, whereas the display of the base unit 104 faces a surface on which the electronic device 100 is placed. In the stand mode of operation, the display 108 of the display unit 102 can be activated, whereas the display 110 of the base unit 104 can be deactivated. The stand mode of operation is similar to the tablet mode of operation in that one display is activated while another display is deactivated. In a different configuration of the stand mode of operation, the display 108 of the display unit can face the surface on which the electronic device 100 is laid, while the display 110 of the base unit 104 is facing the user and presenting information. In such an alternative arrangement, the display 108 of the display unit 102 is deactivated.

Another mode of operation is the book mode of operation where the display unit 102 and the base unit 104 are pivoted with respect to one another and held in an orientation that is similar to a way a user would hold a book when the book is in an open position and the user is reading the book. Such a book orientation is shown in FIG. 2C, where the first display 108 of the display unit 102 can display first information (e.g., one page of a book), while the second display 110 of the base unit 104 displays second information (e.g., a second page of a book).

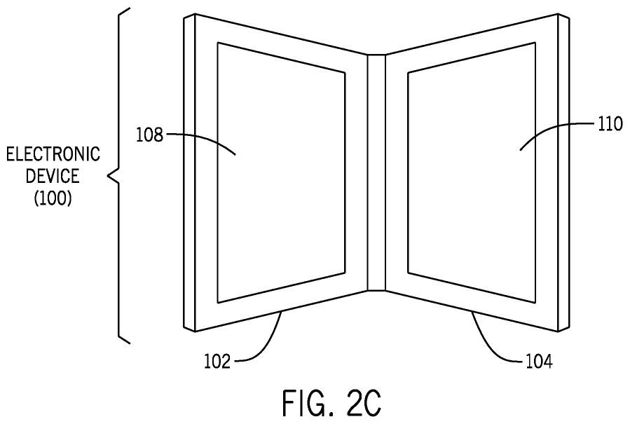

FIG. 3 is a block diagram of the electronic device 100 according to further examples. The electronic device 100 is similar to the electronic device of FIG. 1B, except that additional components are depicted in the electronic device 100 of FIG. 3. The electronic device 100 of FIG. 3 includes a power supply 302, which is able to provide a power supply voltage (or multiple power supply voltages) to power various electronic components of the electronic device 100, including the displays 108 and 110, the processor 114, and the sensors 118. In some examples, during the sleep state of the electronic device 100, the power supply 302 can remove power from the displays 108 and 110 and the processor 114. However, in the sleep state, the power supply 302 can maintain active the power supply voltage that is supplied to the sensors 118, to allow the sensors 118 to continue making measurements that may trigger an event to awaken the electronic device 100.

Similarly, the power supply 302 can continue to supply power to a control button 304 and a network interface 306. The control button 304 can include a power button or a different button of the electronic device 100, which when actuated by a user can indicate that the user desires that the electronic device 100 be awakened from a sleep state to an operational state. The network interface 306 is able to communicate over a network with a remote device. In some examples, a portion of the network interface 306 can be maintained and powered even in the sleep state of the electronic device 100, such that receipt of a packet by the network interface 306 can trigger a wake event to cause the electronic device 100 to be awakened.

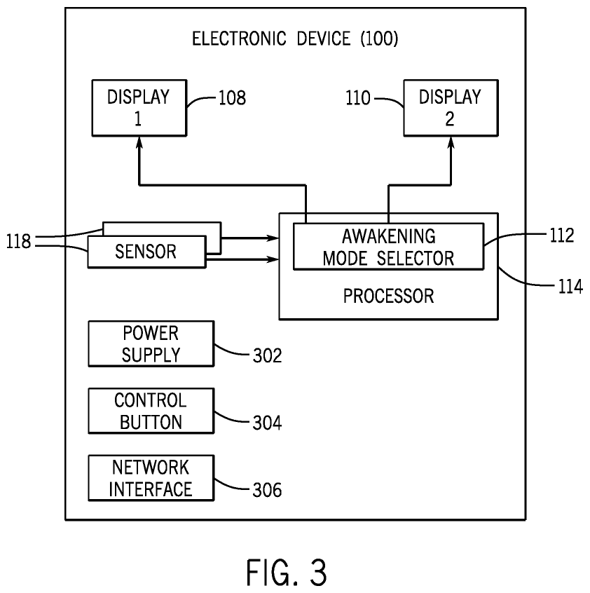

FIG. 4 is a flow diagram of a process that is performed by an electronic device, such as the electronic device 100 of FIG. 1B or 3. FIG. 4 depicts an example where the electronic device can transition to a sleep state from an operational state while the electronic device is in a first mode of operation, and can awaken from the sleep state in a second, different mode of operation.

The process of FIG. 4 includes operating (at 402) the electronic device at a higher power state in the first mode of operation. The process transitions (at 404) the electronic device while in the first mode of operation from the higher power state to the sleep state. In response to a wake event received (at 406) while the electronic device is in the sleep state, the process determines (at 408) outputs of sensors in the electronic device. Based on the outputs of the sensors, the process awakens (at 410) the electronic device from the sleep state to the higher power state in the second mode of operation that is different from the first mode of operation.

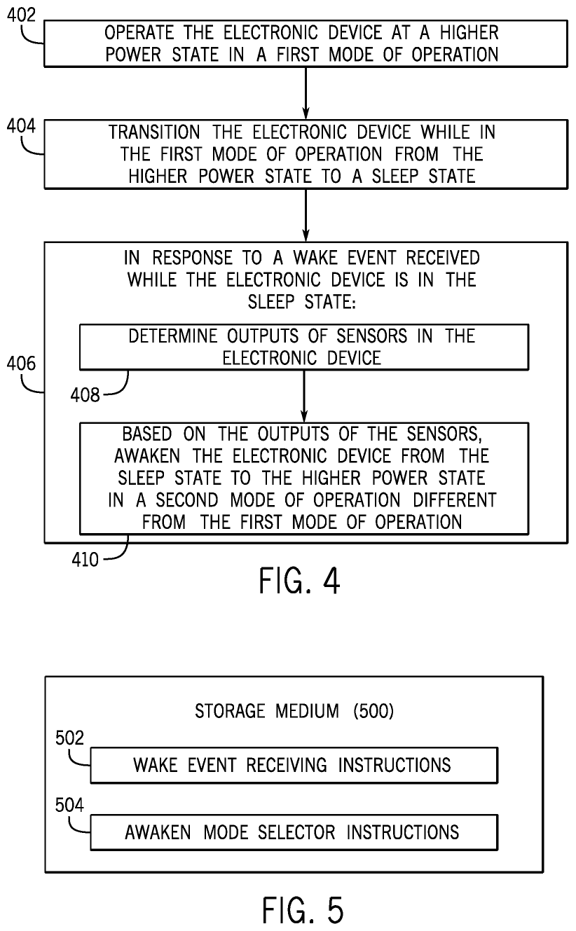

FIG. 5 is block diagram of a non-transitory machine-readable or computer-readable storage medium 500 for storing machine-readable instructions that upon execution cause an electronic device to perform various tasks. The machine-readable instructions include wake event receiving instructions 502 to receive a wake event. In addition, the machine-readable instructions include awakening mode selection instructions 504 to, in response to a wake event, awaken the electronic device from a sleep state to a higher power state in a selected mode of operation of the electronic device that depends on outputs from sensors of the electronic device, the selected mode of operation selected from among multiple different modes of operation that used multiple displays of the electronic device.

The storage medium 500 can be implemented using any or some combination of the following: a semiconductor memory device such as a dynamic or static random access memory (DRAM or SRAM), an erasable and programmable read-only memory (EPROM), an electrically erasable and programmable read-only memory (EEPROM) and a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory storage medium storing instructions that upon execution cause an electronic device to:
receive a wake event; and
in response to the wake event, awaken the electronic device from a sleep state to a higher power state in a selected mode of operation of the electronic device that depends on outputs from sensors of the electronic device, the selected mode of operation selected from among a plurality of different modes of operation that use multiple displays of the electronic device.

2. The non-transitory storage medium of claim 1, wherein a first mode of the plurality of different modes of operation uses a first display of the multiple displays to present a virtual user input device, and a second display of the multiple displays to display a program image.

3. The non-transitory storage medium of claim 2, wherein in the first mode the first display presents a virtual keyboard.

4. The non-transitory storage medium of claim 2, wherein a second mode of the plurality of different modes of operation uses a first display of the multiple displays to present a first program image, and a second display of the multiple displays to display a second program image.

5. The non-transitory storage medium of claim 2, wherein a second mode of the plurality of different modes of operation uses first and second displays of the multiple displays to present a same program image.

6. The non-transitory storage medium of claim 1, wherein a first mode of the plurality of different modes of operation deactivates a first display of the multiple displays, and uses a second display of the multiple displays to display a program image, and
a second mode of the plurality of different modes of operation activates the first and second displays to display information.

7. The non-transitory storage medium of claim 1, wherein the sensors comprise plural sensors selected from among a sensor to detect an angular position of a hinge of the electronic device, a sensor to detect an orientation of the electronic device, a sensor to detect motion of the electronic device, and a sensor to track a focus of a user.

8. The non-transitory storage medium of claim 1, wherein the sensors comprise a sensor to detect ambient light or to detect user presence.

9. The non-transitory storage medium of claim 1, wherein the instructions upon execution cause the electronic device to:
while the electronic device is in a first mode of the plurality of different modes of operation, transition the electronic device from the higher power state to the sleep state,
wherein the selected mode of operation to which the electronic device is transitioned from the sleep state to the higher power state is different from the first mode.

10. An electronic device comprising:
a plurality of displays;
sensors; and
a processor to:
receive a wake event,
receive outputs of the sensors; and
responsive to the wake event, awaken the electronic device from a sleep state to a higher power state in a selected mode of operation that is selected from a plurality of different modes of operation that use the plurality of displays, wherein a first mode of the plurality of different modes of operation uses the plurality of displays in a way that is different from a second mode of the plurality of different modes of operation.

11. The electronic device of claim 10, wherein the wake event is responsive to detecting an interrupt produced responsive to an output of a sensor, an actuation of a control button, or a network connection.

12. The electronic device of claim 10, wherein the plurality of different modes of operation comprise multiple modes of operation selected from among a clamshell mode of the electronic device, a flat mode of the electronic device, a tent mode of the electronic device, a stand mode of the electronic device, a tablet mode of the electronic device, and a book mode of the electronic device.

13. The electronic device of claim 10, further comprising a power supply to power the sensors while the electronic device is in the sleep state.

14. A method of an electronic device, comprising:
operating the electronic device at a higher power state in a first mode of operation;
transitioning the electronic device while in the first mode of operation from the higher power state to a sleep state; and
in response to a wake event received while the electronic device is in the sleep state,
determining outputs of sensors in the electronic device, and
based on the outputs of the sensors, awakening the electronic device from the sleep state to the higher power state in a second mode of operation different from the first mode of operation.

15. The method of claim 14, wherein the first and second modes of operation use displays of the electronic device in different ways, a first display of the displays provided in a first part of the electronic device, and a second display of the displays provided in a second part of the electronic device, the first part pivotally connected to the second part.
